(19) United States
(12) Patent Application Publication
(10) Pub. No.: US 2008/0124659 A1
(43) Pub. Date: May 29, 2008

(54) HEAT TRANSFER FILM AND METHOD OF MANUFACTURING PARTITION WALLS OF PLASMA DISPLAY PANEL USING THE SAME

(76) Inventors: Jin Woo PARK, Seoul (KR); Yoon Kwan Lee, Gyeonggi-do (KR)

Correspondence Address: BIRCH STEWART KOLASCH & BIRCH, PO BOX 747, FALLS CHURCH, VA, 22040-0747, US

(21) Appl. No.: 11/772,678

(22) Filed: Jul. 2, 2007

(30) Foreign Application Priority Data
Jul. 3, 2006 (KR) 10-2006-0061954

(51) Int. Cl. G03C 5/00; B32B 7/00

(52) U.S. Cl. 430/322; 428/120

(57) ABSTRACT

A heat transfer film and a method of manufacturing partition walls of a plasma display panel using the same are disclosed. The heat transfer film includes a base film, a light-heat transforming layer formed on the base film, and a partition wall material layer formed on the light-heat transforming layer.

### CROSS-REFERENCE TO RELATED APPLICATION

This application claims the benefit of Korean Patent Application No. 10-2006-0061954, filed on Jul. 3, 2006, which is hereby incorporated by reference in its entirety as if fully set forth herein.

### BACKGROUND OF THE INVENTION

1. Field of the Invention

The present invention relates to a heat transfer film and a method of manufacturing partition walls of a plasma display panel using the same.

2. Discussion of the Related Art

A plasma display panel (PDP) is a light emitting device which displays images using an electrical discharge phenomenon. It is unnecessary to mount an active device in each pixel, thereby allowing a simple manufacturing process, a large screen and a high response speed. Accordingly, the plasma display panel (PDP) has been widely used for an image display device having a large-sized screen.

As shown in FIG. 1, the plasma display panel has a structure wherein an upper panel 10 and a lower panel 20 are overlapped to face each other. The upper panel 10 includes a pair of sustain electrodes arranged on the inner surface of a transparent substrate 11. The sustain electrodes include transparent electrodes 12 and bus electrodes 13.

The sustain electrodes are coated with a dielectric layer 14 for AC driving. A protective film 15 is formed on the dielectric layer 14.

Meanwhile, address electrodes 22 are arranged on a lower plate 21 on the inner surface of the lower panel 20. A dielectric layer 23 is formed on the address electrodes 22. Stripe or well type partition walls 24 are formed on the dielectric layer 23 to separate the address electrodes 22 from each other. Red, blue and green phosphor layers 26 for displaying colors are coated on cells defined by the partition walls 24 to form sub-pixels.

Discharge cells 25 are formed on the respective sub-pixels by the partition walls 24. Further, discharge gas is sealed in the discharge cells 25. One pixel includes three sub-pixels.

Generally, a printing method, a sand blasting method, an etching method and a photolithography method using a photoresist material are employed as a method of forming the partition walls 24.

The printing method is a method of forming partition walls in a desired state by printing glass paste having high thixotropy many times. In the sand blasting method, a dry film resist (DFR) is coated on a partition wall material before plasticization. Then, the dry film resist (DFR) is developed by exposure to light using a photomask. A partition wall pattern is formed through sand blasting using the patterned DFR as a mask, thereby plasticizing the partition walls.

Further, the etching method is similar to the sand blasting method. However, in the etching method, the partition walls are formed using an etching solution instead of sand blasting.

Recently, two etching methods are widely used, wherein the DFR coated on the partition wall material is a film in one method, and the DFR is a liquid photo resist (PR) in the other method. That is, the two etching methods have a material difference.

However, in the conventional method of forming the partition walls, it is difficult to obtain the partition walls having a fine pitch. Further, since an expensive photomask is used in patterning, there are problems such as an increase in the number of steps and a cost increase.

Therefore, in order to overcome the above-mentioned problems, it is required to develop an advanced method of forming the partition walls of the plasma display panel. Further, the advanced method is required for other application fields without being limited to the plasma display panel.

### SUMMARY OF THE INVENTION

Accordingly, the present invention is directed to a heat transfer film and a method of manufacturing partition walls of a plasma display panel using the same that substantially obviate one or more problems due to limitations and disadvantages of the related art.

An object of the present invention is to provide a heat transfer film and a method of manufacturing partition walls of a plasma display panel using the same capable of forming the partition walls having a fine pitch through a simple process at low cost.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a heat transfer film includes a base film, a light-heat transforming layer formed on the base film, and a partition wall material layer formed on the light-heat transforming layer.

Preferably, the light-heat transforming layer includes at least one selected from a group consisting of an organic film containing a laser light absorptive material, metal, metal oxide, metal sulfide and a combination thereof. Further, the partition wall material layer includes glass powder having a softening point ranging from 300 to 600° C.

Preferably, the glass powder includes one selected from a group consisting of a mixture of lead oxide (Pbo), boron oxide (B₂O₃) and silicon oxide (SiO₂), a mixture of zinc oxide (ZnO), boron oxide (B₂O₃) and silicon oxide (SiO₂), a mixture of lead oxide (PbO), boron oxide (B₂O₃), silicon oxide (SiO₂) and aluminum oxide (Al₂O₃), and a mixture of lead oxide (Pbo), zinc oxide (ZnO), boron oxide (B₂O₃) and silicon oxide (SiO₂). Further, the partition wall material layer is coated as photosensitive paste, a sheet or slurry.

Preferably, the heat transfer film further includes a transmission layer between the light-heat transforming layer and the partition wall material layer.

In another aspect of the present invention, a method of manufacturing partition walls of a plasma display panel using a heat transfer film includes forming the heat transfer film including a base film, a light-heat transforming layer and a partition wall material layer on a substrate, illuminating light on the heat transfer film, and separating the heat transfer film from the substrate to form a partition wall pattern on the substrate.

Preferably, the light is laser light having a wavelength of about 300˜450 nm.

Preferably, the partition wall material layer of the heat transfer film includes photosensitive paste and glass powder.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a perspective view of a general plasma display panel;

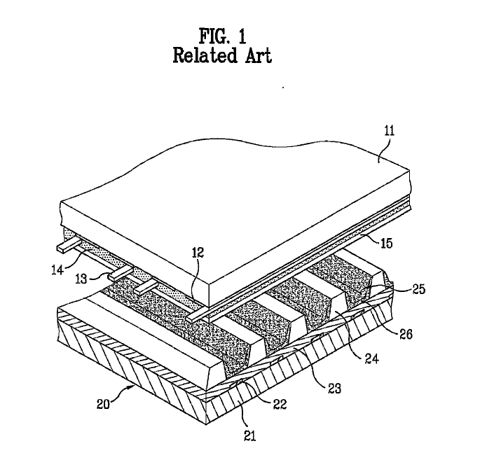

FIG. 2 shows a structure of a heat transfer film according to one embodiment of the present invention;

FIG. 3 is a block diagram schematically showing a method of manufacturing partition walls according to the embodiment of the present invention;

FIGS. 4A to 4D show a process for manufacturing partition walls according to another embodiment of the present invention; and

FIG. 5 shows a cross-sectional view of a plasma display panel manufactured using a method of manufacturing a plasma display panel according to yet another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

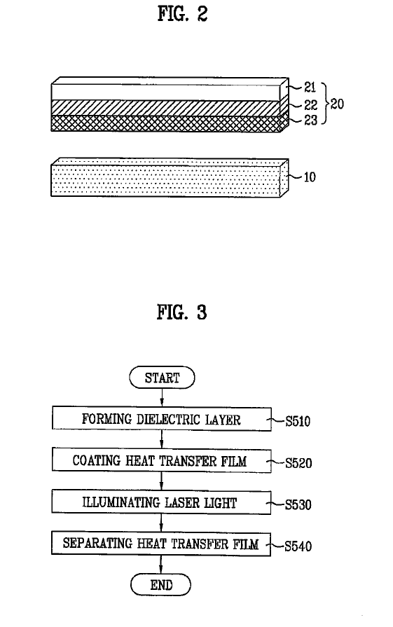

FIG. 2 shows a structure of a heat transfer film 20 according to one embodiment of the present invention. As shown in FIG. 2, the heat transfer film 20 may include a base film 21, a light-heat transforming layer 22 formed on the base film 21, and a partition wall material layer 23 formed on the light-heat transforming layer 22. Although not shown in the drawing, the heat transfer film 20 may further include a transmission layer between the light-heat transforming layer 22 and the partition wall material layer 23. FIG. 2 shows arrangement of the heat transfer film 20 including the partition wall material layer 23, the light-heat transforming layer 22 and the base film 21 before the heat transfer film 20 is disposed on a substrate 10. The partition wall material layer 23 of the heat transfer film 20 faces the substrate 10 to be attached to the surface of the substrate 10.

In the heat transfer film 20 according to the embodiment of the present invention, a portion where partition walls are formed is illuminated with light from a light source such as a laser. The illuminated light is transformed into heat through the light-heat transforming layer 22, whereby the partition wall material layer 23 is selectively transferred on the substrate 10. In this case, the light-heat transforming layer 22 may absorb light from an energy source such as the laser, a xenon (Xe) lamp and a flash lamp. It is preferable to use the laser capable of achieving the most excellent transfer performance. The laser may be a common laser such as a solid laser, a gas laser, a semiconductor laser, and a dye laser.

The base film 21 is formed of, preferably, a transparent polymer, but the material of the base film 21 is not limited thereto. The polymer may include polyethylene, polyester terephthalate, polyacryl, polyepoxy, polyethylene, polystyrene and the like. Generally, a polyethylene terephthalate film is used for the base film 21.

Preferably, the base film 21 is a thickness of about 10˜500 μm. The base film 21 serves as a support film.

The light-heat transforming layer 22 is made of a light absorptive material capable of absorbing light, which is one selected from a group consisting of an organic film including a laser light absorptive material, metal and a combination thereof. The film having the properties includes metal, oxide and sulfide of the metal, an organic film made of a polymer containing carbon black, graphite or infrared dye.

In this case, the metal and oxide and sulfide of the metal may include metal such as aluminum (Al), silver (Ag), chrome (Cr), tin (Sn), nickel (Ni), titanium (Ti), cobalt (Co), zinc (Zn), gold (Au), copper (Cu), tungsten (W), molybdenum (Mo), lead (Pb), oxide thereof, and a mixture thereof. It is preferable to use aluminum (Al), silver (Ag) and oxide thereof.

The organic film made of a polymer containing carbon black, graphite or infrared dye may include only (meta)acrylate oligomer such as acryl (meta)acrylate oligomer, ester (meta)acrylate oligomer, epoxy (meta)acrylate oligomer and urethane (meta)acrylate oligomer, which is an organic substance in which a coloring agent or a dispersing agent such as paint and dye is dispersed in polymer-containing resin. Further, the organic film may include a mixture of oligomer and (meta)acrylate monomer or only (meta)acrylate monomer. It is preferable to use carbon black or graphite having a particle diameter of 0.5 μm or less and an optical density of 0.1˜4.

The light-heat transforming layer 22 may include a material for improving transfer performance to efficiently transfer the partition wall material layer 23. That is, the light-heat transforming layer 22 may include a material for providing a pressure required to transfer the partition wall material layer 23 of a light-exposed region. Preferably, the light-heat transforming layer 22 may include a polymer having a relatively low decomposition temperature (about 350° C. or less, generally, about 325° C. or less, more generally, about 280° C. or less), but it is not limited thereto. In case of a polymer having one or more decomposition temperature, the first decomposition temperature should be 350° C. or less.

The light-heat transforming layer 22 may be formed to have a single-layer or multi-layer structure.

A polymer used for the transmission layer may include (a) polycarbonate having a low decomposition temperature (Td) such as polypropylene carbonate; (b) a substituted styrene polymer having a low decomposition temperature such as poly(alpha-methylstyrene); (c) polyacrylate and polymethacrylate ester such as polymethylmethacrylate and polybutylmethacrylate; (d) a cellulose substance having a low decomposition temperature (Td) such as cellulose acetate butyrate and nitrocellulose; and (e) other polymers such as polyvinyl chloride, poly(chlorovinyl chloride) polyacetal, polyvinylidene chloride, polyurethane having a low decomposition temperature (Td), polyester, polyorthoester, acrylonitrile, a substituted acrylonitrile polymer, maleic acid resin and a copolymer thereof. Further, the transmission layer may include a polymer mixture.

Further, the transmission layer may include a material which emits nitrogen gas, hydrogen gas or the like due to decomposition reaction occurring when it absorbs light or heat, for example, pentaerythritol tetranitrate (PETN) and trinitrotoluene (TNT).

The partition wall material layer 23 may include a pasted material containing a partition wall material, but it is not limited thereto. Further, the partition wall material layer 23 may be coated as photosensitive paste, a sheet or slurry. The partition wall material layer 23 includes glass powder having a softening point ranging from 300 to 600° C. The glass powder may be one selected from a group consisting of a mixture of lead oxide (Pbo), boron oxide (B₂O₃) and silicon oxide (SiO₂), a mixture of zinc oxide (ZnO), boron oxide (B₂O₃) and silicon oxide (SiO₂), a mixture of lead oxide (Pbo), boron oxide (B₂O₃), silicon oxide (SiO₂) and aluminum oxide (Al₂O₃), and a mixture of lead oxide (PbO), zinc oxide (ZnO), boron oxide (B₂O₃) and silicon oxide (SiO₂).

The partition wall material layer 23 may include a binder. The binder may be made of a polymer having a decomposition temperature of about 250° C. or more, particularly, about 350° C. or more. A photoresist may be used as the binder. Preferably, the binder forms a film capable of being coated with solution or dispersion solution. A commonly-used binder has a melting point of about 250° C. or less, and is plasticized at a glass transition temperature of about 70° C. or less. Further, a binder capable of being easily liquefied or heat-melted, for example, low-melting wax, efficiently serves as a cobinder to lower a melting point of a texture layer. However, if the binder has fluidity or low durability, it should be avoided to use it alone.

When the binder is transferred together with other texture material, generally, a polymer of the binder is not self-oxidized, decomposed or deteriorated at the temperature reached when it is exposed to a laser. By such selection, an exposed region of the texture layer including the texture material and the binder is transferred without being damaged, thereby obtaining improved durability.

The binder may include a copolymer of styrene and (meth)acrylate ester such as styrene/methyl-methacrylate; a copolymer of styrene and an olefin monomer such as styrene/ethylene/butylenes; a copolymer of styrene and acrylonitrile; a fluoropolymer; a copolymer of (meth)acrylate ester, ethylene and carbon monoxide; polycarbonate having a proper decomposition temperature; a (meth)acrylate polymer and a copolymer of (meth)acrylate; polysulfone; polyurethane; and polyester. A monomer for the polymer may be substituted or unsubstituted. A substituent may include halogen, oxygen and nitrogen containing a substituent. A polymer mixture may be used as the substituent.

A transmission layer (not shown) may be further disposed between the light-heat transforming layer 22 and the partition wall material layer 23. The transmission layer may include a material for improving transfer performance to efficiently transfer the partition wall material layer 23. That is, the transmission layer may include a material for providing a pressure required to transfer the partition wall material layer of a light-exposed region. Preferably, the transmission layer may include a polymer having a relatively low decomposition temperature (about 350° C. or less, generally, about 325° C. or less, more generally, about 280° C. or less), but it is not limited thereto. In case of a polymer having one or more decomposition temperature, the first decomposition temperature should be about 350° C. or less. When heat transfer is performed by transmission of illuminated laser light through the transmission layer, the transmission layer should transmit the illuminated laser light and should not be damaged by the illuminated laser light.

A polymer used for the transmission layer may include (a) polycarbonate having a low decomposition temperature (Td) such as polypropylene carbonate; (b) a substituted styrene polymer having a low decomposition temperature such as poly(alpha-methylstyrene); (c) polyacrylate and polymethacrylate ester such as polymethylmethacrylate and polybutylmethacrylate; (d) a cellulose substance having a low decomposition temperature (Td) such as cellulose acetate butyrate and nitrocellulose; and (e) other polymers such as polyvinyl chloride, poly(chlorovinyl chloride) polyacetal, polyvinylidene chloride, polyurethane having a low decomposition temperature (Td), polyester, polyorthoester, acrylonitrile, substituted acrylonitrile polymer, maleic acid resin and a copolymer thereof. Further, the transmission layer may include a polymer mixture.

Further, the transmission layer may include a material which emits nitrogen gas, hydrogen gas or the like due to decomposition reaction occurring when it absorbs light or heat, for example, pentaerythritol tetranitrate (PETN) and trinitrotoluene (TNT).

On the other hand, a method of manufacturing partition walls of a plasma display panel using the heat transfer film according to the present invention includes the steps of forming the heat transfer film 20 including a base film, a light-heat transforming layer and a partition wall material layer on the substrate 10; illuminating light on the heat transfer film 20; and separating the heat transfer film 20 from the substrate 10 to form a pattern of partition walls 11 on the substrate 10.

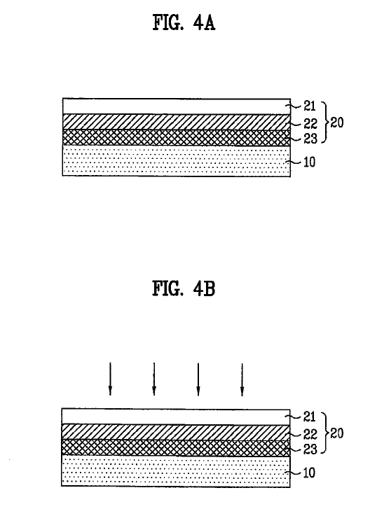

FIG. 3 is a block diagram schematically showing the method of manufacturing partition walls of a plasma display panel according to the embodiment of the present invention. As shown in FIG. 3, a dielectric layer is formed on a lower substrate (S510). Then, the above-described heat transfer film is coated on the dielectric layer (S520). Then, laser light is illuminated on the heat transfer film such that the heat transfer film is patterned into a partition wall pattern (S530). Then, the heat transfer film is separated from the lower substrate to form partition walls on the dielectric layer in accordance with the partition wall pattern (S540).

In the method of manufacturing partition walls according to the present invention, laser light is selectively illuminated without an additional photomask, and a conventional developing process is not necessary. However, the developing process may be added in the method according to the present invention.

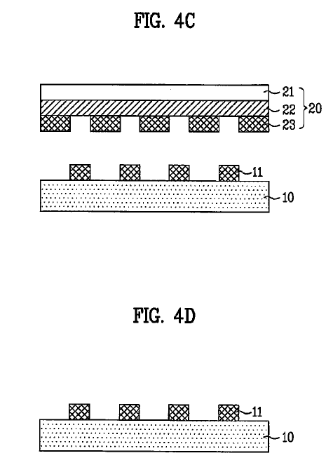

FIGS. 4A to 4D show a process for manufacturing the partition walls 11 using the above-described heat transfer film 20 according to another embodiment of the present invention.

First, as shown in FIG. 4A, the above-described heat transfer film 20 is deposited on the substrate 10. Since the heat transfer film is described in detail before, the description thereof is omitted.

In this case, the substrate 10 may be a glass substrate, a plastic substrate, or a transparent electrode.

Next, as shown in FIG. 4B, light is illuminated on the heat transfer film 20 in accordance with a partition wall pattern to be formed. In this case, light may be illuminated on the heat transfer film or on the substrate.

An energy source used in this embodiment may be a laser, a xenon (Xe) lamp, a flash lamp or the like. It is preferable to use the laser capable of achieving the most excellent transfer performance. The laser may be a common laser such as a solid laser, a gas laser, a semiconductor laser, and a dye laser. Further, laser beam may have a circular shape or other shapes.

It is preferable that laser light has a wavelength of about 300˜450 nm.

The light activates the light-heat transforming layer 22 through a transfer device, thereby emitting heat by heat decomposition reaction. The emitted heat causes decomposition reaction in the light-heat transforming layer or the transmission layer. Further, since expansion is also generated, the partition wall material layer 23 is separated from the heat transfer film 20 and partition walls are transferred on the substrate 10 in a desired pattern.

Next, as shown in FIG. 4C, the heat transfer film 20 is separated from the substrate 10. Since a region on which light is not illuminated is attached on the heat transfer film 20, the region is also removed by separating the heat transfer film 20 from the substrate 10. Accordingly, the partition walls 11 are formed on the region on which light is selectively illuminated and transfer is performed.

Thereafter, as shown in FIG. 4D, the transferred partition walls are plasticized to complete the partition walls 11.

On the other hand, the above-described method of manufacturing partition walls may be used in any case of manufacturing patterned partition walls independent of application fields. Particularly, the above-described method may be applied to a method of manufacturing electrodes of a plasma display panel.

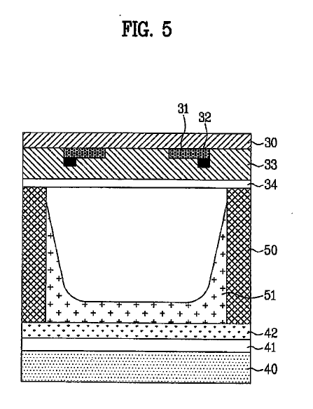

FIG. 5 shows a cross-sectional view of a plasma display panel manufactured using a method of manufacturing a plasma display panel according to yet another embodiment of the present invention. As shown in FIG. 5, the plasma display panel includes a front plate having a pair of sustain electrodes 31 formed to be spaced into a specified pattern in a bottom portion of a front substrate 30, a front dielectric layer 33 formed to cover the sustain electrodes 31 and a protective film layer 34 formed on the bottom of the front dielectric layer 33; a rear plate having address electrode 41 formed on a rear substrate 40 to be perpendicular to a pair of the sustain electrodes 31; and partition walls 50 formed on the rear plate to define a discharge space. A pair of bus electrodes 32 shown in FIG. 5 may be omitted. A phosphor layer 51 may be coated on the partition walls and the rear plate. The plasma display panel further includes a rear dielectric layer 42. The structure of the plasma display panel according to the present invention is not limited to the structure shown in the drawing. Modification, addition, and omission may be made using any technique known in the art.

In addition to the partition walls 50 of the plasma display panel, a pair of the sustain electrodes 31, a pair of the bus electrodes 32, or the address electrode 41 may be manufactured using the above-described heat transfer film 20. Further, it is possible to improve the method of manufacturing electrodes using the heat transfer film 20.

First, the protective film layer 34 is formed on the front dielectric layer 33 to complete the front plate of the plasma display panel. The protective film layer prevents the front dielectric layer from being damaged by sputtering, thereby increasing secondary electron emission efficiency as well as prolonging the life of PDP. The material of the protective film layer may include magnesium oxide (MgO), zirconium oxide (ZrO), hafnium oxide (HfO), cesium oxide (CeO₂), thorium oxide (ThO₂), lanthanium oxide (La₂O₃), or the like. It is most preferable to use magnesium oxide (MgO) having a high secondary electron emission coefficient and excellent plasma resistance. The magnesium oxide (MgO) may be formed using a vacuum deposition method such an electron beam deposition method.

The rear plate is manufactured separately from the above-described front plate.

First, the address electrode 41 is formed on the rear substrate 40 to be perpendicular to a pair of the sustain electrodes.

Then, the rear dielectric layer 42 is formed to cover the address electrode (or omitted).

Then, the partition walls 50 are formed on the rear dielectric layer. The material and structure of the partition walls 50 may vary using any technique known in the art. For example, the partition walls may be stripe-type partition walls, closed-type partition walls or delta-type partition walls. Preferably, the partition walls are formed using the heat transfer film 20 according to one embodiment of the present invention.

Then, the phosphor layer 51 is coated on the rear dielectric layer and the partition walls 50, and they are attached to the front plate, thereby completing the plasma display panel.

In this case, the partition walls 50 are formed using the heat transfer film by laser patterning in a transfer process. Thus, it is possible to form the partition walls having a fine pitch without using a photomask by simplifying the process and reducing material and process costs.

Further, graded partition walls having different heights in horizontal and vertical directions may be formed by controlling the wavelength of illuminated laser light in a transfer process of the above-described method. For example, the illuminated laser light has a wavelength in a range of about 360˜370 nm or about 400˜410 nm, most preferably, a wavelength of about 365 nm or about 405 nm.

As described above, in the heat transfer film and the method of manufacturing partition walls of a plasma display panel using the same according to the present invention, the partition walls can be formed through a simple process using laser light or the like without using a mask. Accordingly, it is possible to simplify the process and reduce the mask cost compared to a conventional partition wall manufacturing method having a problem such as high process cost. Thus, the method according to the present invention is appropriate for scaling-up and mass production. Further, since the developing process is not necessary, a partition wall material can be saved, thereby providing effects such as cost reduction.

Further, it is possible to form the partition walls having a fine pitch through a simple process, thereby increasing stability of the partition walls.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A heat transfer film comprising:
a base film;
a light-heat transforming layer formed on the base film; and
a partition wall material layer formed on the light-heat transforming layer.

2. The heat transfer film according to claim 1, wherein the light-heat transforming layer includes at least one selected from a group consisting of an organic film containing a laser light absorptive material, metal, metal oxide, metal sulfide and a combination thereof.

3. The heat transfer film according to claim 1, wherein the light-heat transforming layer includes at least one selected from a group consisting of polycarbonate having a low decomposition temperature, a styrene polymer, polyacrylate, polymethacrylate ester, a cellulose substance, polyvinyl chloride, poly (chlorovinyl chloride) polyacetal, polyvinylidene chloride, polyurethane, polyester, polyorthoester, acrylonitrile, a substituted acrylonitrile polymer, maleic acid resin and a copolymer thereof.

4. The heat transfer film according to claim 1, wherein the light-heat transforming layer is formed to have a single-layer or multi-layer structure.

5. The heat transfer film according to claim 1, wherein the partition wall material layer includes glass powder having a softening point ranging from 300 to 600° C.

6. The heat transfer film according to claim 5, wherein the glass powder includes one selected from a group consisting of a mixture of lead oxide (PbO), boron oxide (B₂O₃) and silicon oxide (SiO₂), a mixture of zinc oxide (ZnO), boron oxide (B₂O₃) and silicon oxide (SiO₂), a mixture of lead oxide (PbO), boron oxide (B₂O₃), silicon oxide (SiO₂) and aluminum oxide (Al₂O₃), and a mixture of lead oxide (PbO), zinc oxide (ZnO), boron oxide (B₂O₃) and silicon oxide (SiO₂).

7. The heat transfer film according to claim 1, wherein the partition wall material layer is coated as photosensitive paste, a sheet or slurry.

8. The heat transfer film according to claim 1, further comprising a transmission layer between the light-heat transforming layer and the partition wall material layer.

9. The heat transfer film according to claim 8, wherein the transmission layer includes at least one selected from a group consisting of polycarbonate having a low decomposition temperature, a styrene polymer, polyacrylate, polymethacrylate ester, a cellulose substance, polyvinyl chloride, poly(chlorovinyl chloride) polyacetal, polyvinylidene chloride, polyurethane, polyester, polyorthoester, acrylonitrile, a substituted acrylonitrile polymer, maleic acid resin and a copolymer thereof.

10. A method of manufacturing partition walls of a plasma display panel using a heat transfer film, comprising:
forming the heat transfer film including a base film, a light-heat transforming layer and a partition wall material layer on a substrate;
illuminating light on the heat transfer film; and
separating the heat transfer film from the substrate to form a partition wall pattern on the substrate.

11. The method according to claim 10, wherein the light is laser light having a wavelength of about 300˜450 nm.

12. The method according to claim 10, further comprising, before the step of forming the heat transfer film on a substrate, the step of forming a dielectric layer on the substrate.

13. The method according to claim 10, wherein the partition wall material layer of the heat transfer film includes photosensitive paste.

14. The method according to claim 10, wherein the partition wall material layer of the heat transfer film includes glass powder.

15. The method according to claim 10, wherein in the step of illuminating light on the heat transfer film, graded partition walls having different heights in horizontal and vertical directions are formed by controlling a wavelength of the light such that a wavelength of the light illuminated horizontally is different from a wavelength of the light illuminated vertically.

16. The method according to claim 15, wherein the wavelength of the light is in a range of about 360˜370 nm or about 400˜410 nm.

17. The method according to claim 15, wherein the graded partition walls have a height in the vertical direction greater than that in the horizontal direction.
